(19) United States
(12) Patent Application Publication
(10) Pub. No.: US 2009/0111070 A1
(43) Pub. Date: Apr. 30, 2009

(54) Ultrasonic insert with soft grip and method

(76) Inventors: David P. Pollock, York, PA (US); Peter H. Werner, Columbia, PA (US); Kenneth S. Peterson, Lancaster, PA (US)

Correspondence Address: DENTSPLY INTERNATIONAL INC, 570 WEST COLLEGE AVENUE, YORK, PA, 17404, US

(21) Appl. No.: 11/980,834

(22) Filed: Oct. 31, 2007

(51) Int. Cl. A61C 1/07

(52) U.S. Cl. 433/119

(57) ABSTRACT

The invention provides an ultrasonic dental scaler insert having a soft grip, and a method of making it. In the method a soft grip member is provided having an elastomeric wall affixed to a rigid wall. This soft grip member is then connected to an ultrasonic dental scaler insert to form an ultrasonic dental scaler insert having a soft grip.

The invention provides an ultrasonic dental scaler insert having a soft grip, and a method of making it.

### BRIEF DESCRIPTION OF THE DRAWINGS

FIG. 1 is a perspective view of an ultrasonic dental insert having a soft grip member in accordance with the invention in a handpiece with a cable.

FIG. 2 is a cross-sectional side view of the ultrasonic dental insert in a handpiece of FIG. 1, but without the cable.

FIG. 3 is a perspective view of the ultrasonic dental insert having a soft grip member of FIG. 1.

FIG. 4 is a cross-sectional bottom view of an ultrasonic dental insert having a soft grip member of FIG. 3.

FIG. 5 is a perspective view of a soft grip member in accordance with the invention.

FIG. 6 is a cross-sectional side view of the soft grip member of FIG. 5.

FIG. 7 is a perspective side view of half of a nozzle having grip layer.

FIG. 8 is a perspective side view of half of the nozzle having grip layer of FIG. 7, and positioned adjacent to an ultrasonic dental insert.

FIG. 9 is a perspective side view of a nozzle having grip layer affixed to an ultrasonic dental insert in accordance with the invention.

### DETAILED DESCRIPTION OF THE INVENTION

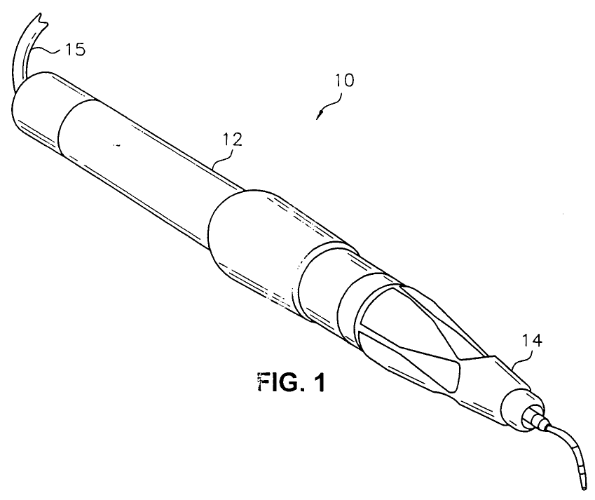

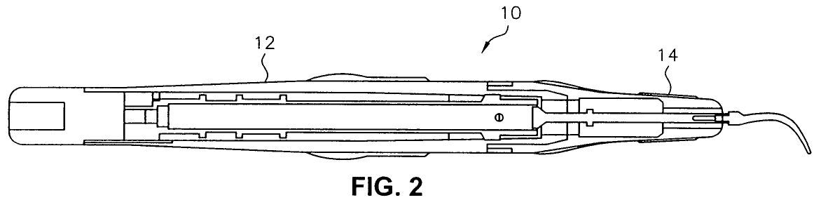

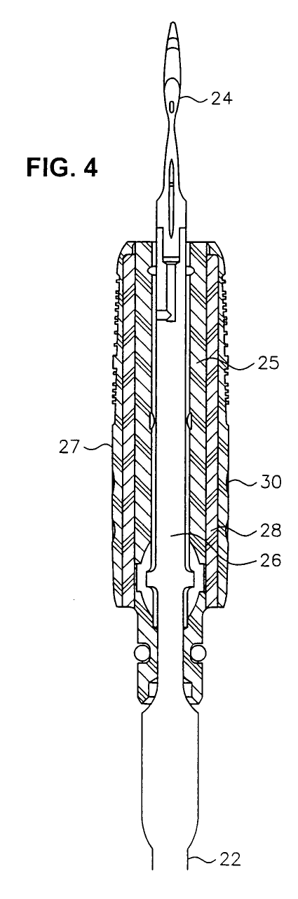

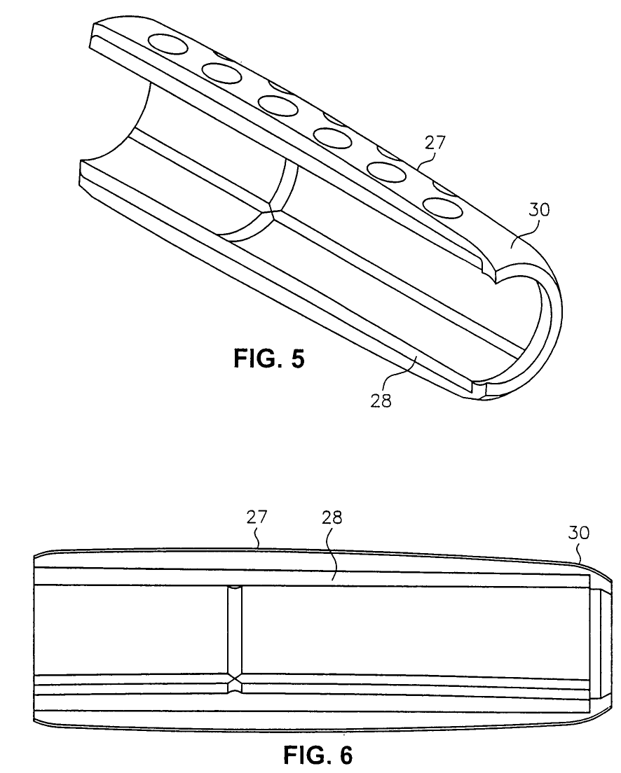

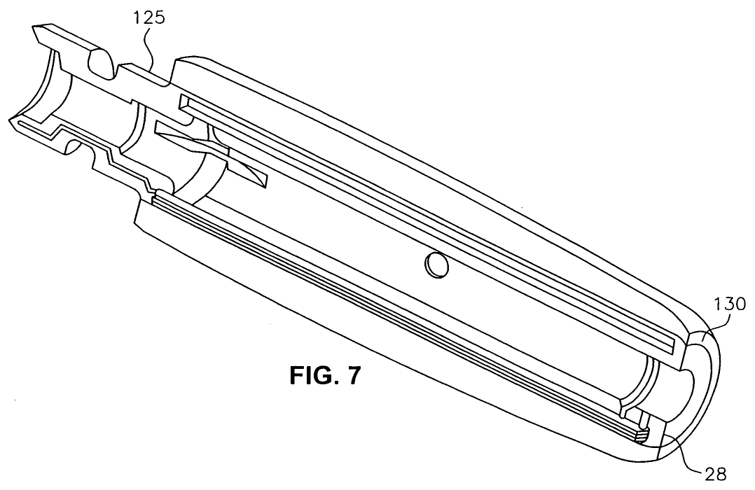

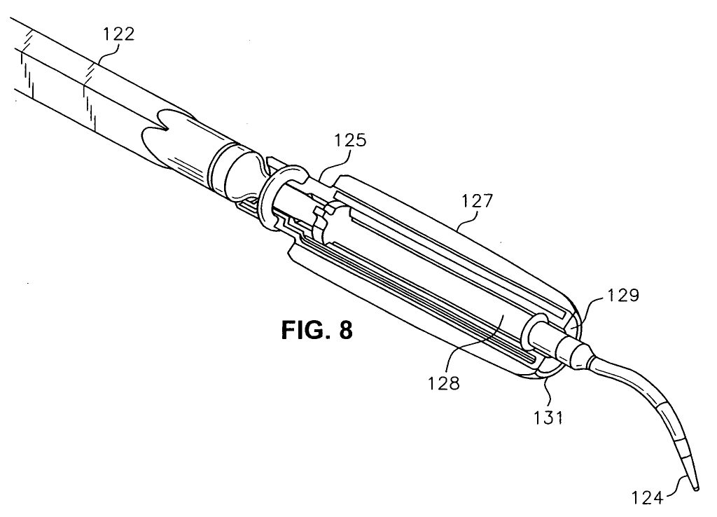

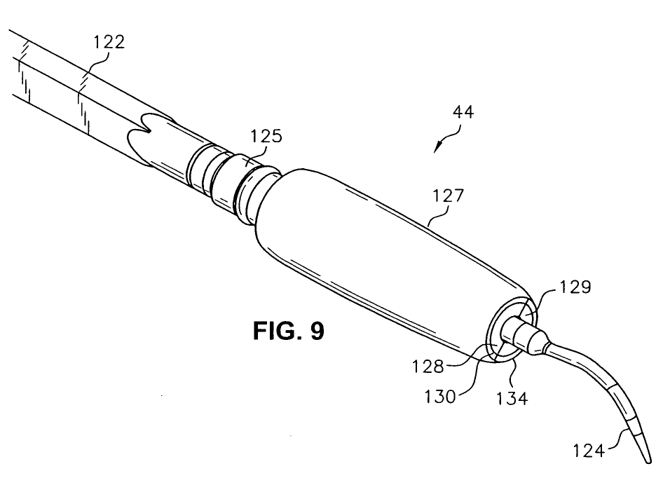

The invention is now described with reference to FIGS. 1 through 9. With more particular reference to FIGS. 1 and 2 it is seen that handpiece 10 comprises an elongated housing 12 which is adapted to receive insert 14 into one end. Cable 15 is attached at the opposite end of elongated housing 12. Cable 15 encloses hoses for delivering air, powder, and/or water to the handpiece 10. Cable 15 also encloses electrical wires connected to coils in elongated housing 12.

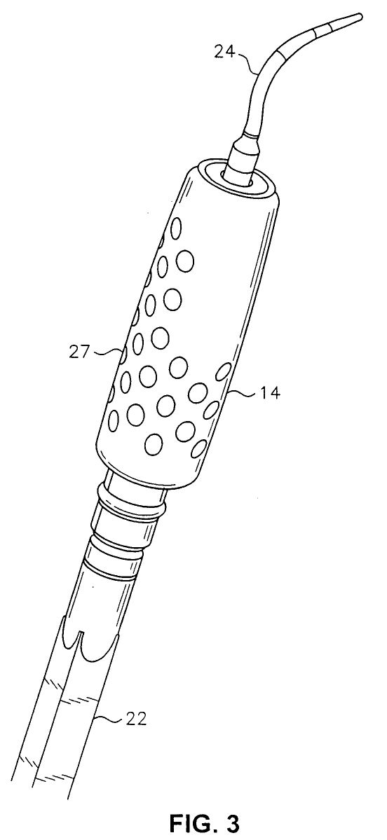

With more particular reference to FIGS. 3 through 6 it is seen that insert 14 has magnetostrictive stack 22 and tip 24 connected to opposite ends of connector 26. Connector 26 supports nozzle 25. Insert 14 has soft grip member 27 having a rigid polymeric inner wall 28 and elastomeric outer wall 30. Soft grip member 27 is press fit onto nozzle 25 of connector 26. Exemplary, rigid polymeric material for use in accordance with the invention include Nylon 6; Nylon 6,6; polypropylene and liquid crystal polymer.

The elastomeric material of outer wall 30 provides a soft, non-slip grip surface for the user to hold onto insert 14. Elastomeric material of outer wall 30 functions as a vibration absorber (or vibration insulator) to reduce the amount of vibration transferred to hand of the user holding insert 14. Nozzle 25 is preferably made of rigid polymeric material. Magnetostrictive stack 22, tip 24 and connector 26 are preferably made of metal.

Preferably, elastomeric outer wall 30 is molded onto rigid polymeric inner wall 28. Elastomeric material may be applied to rigid inner wall 28, for example, by injection molding of fluid, which forms elastomeric material. Preferably, as the elastomeric material solidifies to form the elastomeric material of outer wall 30, a bond forms between the elastomeric material and the rigid material of inner wall 28. Preferably this bond retains its strength in a sterilizing environment. A sterilizing environment may, for example, be heated to 135° C. for 14 minutes at 220 kPa pressure. Preferably, all of the materials used are autoclavable. Alternatively, outer wall 30 and inner wall 28 are separately molded. Then outer wall 30 and inner wall 28 are adhered together by applying an adhesive layer between them.

With more particular reference to FIGS. 7 through 9 it is seen that insert 114 has magnetostrictive stack 122 and tip 124 connected to opposite ends of connector 126. Connector 126 supports nozzle 125. Insert 114 has soft grip member 127 having a rigid polymeric half nozzle walls 128 and 129 and elastomeric outer walls 130 and 131. Two halves of nozzle 125 are positioned to circumscribe connector 126. Then the two halves of nozzle 125 are adhered together.

Preferably elastomeric outer wall 130 is molded onto rigid polymeric half nozzle wall 128, for example by injection molding. Similarly, elastomeric outer wall 131 may be molded onto rigid polymeric half nozzle wall 129, for example by injection molding. Thus, elastomeric outer wall 130 may be molded onto rigid polymeric material of half nozzle wall 128 by injection molding of a fluid which forms the elastomeric material. Similarly, elastomeric outer wall 131 may be molded onto rigid polymeric material of half nozzle wall 129 by injection molding of a fluid which forms the elastomeric material. Preferably as the fluid forms the elastomeric material of outer wall 130 it forms a bond to the rigid polymeric material of half nozzle wall 128. Similarly, as the fluid forms the elastomeric material of outer wall 131 it forms a bond to the rigid polymeric material of half nozzle wall 129.

Alternatively, elastomeric outer wall 130 and half nozzle wall 128 may be adhered together by applying adhesive between them. Similarly, elastomeric outer wall 131 and half nozzle wall 129 may be adhered together by applying adhesive between them. Preferably, these bonds effectively retain their strength in a sterilizing environment. The elastomeric material of outer walls 130 and 131 provides a soft, non-slip grip surface for the user to hold insert 114. Also, elastomeric material of outer walls 130 and 131 functions as a vibration insulator for the user holding insert 114.

Nozzle 125 is preferably made by adhering half nozzle wall 128 to half nozzle wall 129. The adjacent sides of elastomeric material of outer walls 130 and 131 are preferably adhered together. Magnetostrictive stack 122, tip 124 and connector 126 are preferably made of metal. In use the insert 114 with nozzle 125 and elastomeric outer wall 130, is inserted into an elongated housing, such as elongated housing 12 to form a dental handpiece for ultrasonic cleaning of teeth.

Thus, in accordance with the invention is provided a method of making an ultrasonic dental scaler insert having a soft grip. This ultrasonic dental scaler insert is made by providing a soft grip member having an elastomeric wall affixed to a rigid wall, and connecting the soft grip member to an ultrasonic dental scaler insert to form an ultrasonic dental scaler insert having a soft grip. The ultrasonic dental scaler insert has a tip, a connector, and a magnetostrictive member. The connector has a first connector end connected to the tip, and a second connector end, connected to the magnetostrictive member. In one embodiment of the invention the rigid wall is generally cylindrical, and the soft grip is snap-fit onto the connector. In another embodiment of the invention the nozzle is formed by the rigid wall.

While present embodiments of the invention and methods of practicing the same have been illustrated and described, it will be recognized by those skilled in the art that this invention may be otherwise variously embodied and practiced within the scope of the following claims.

What is claimed is:

1. A method of making an ultrasonic dental scaler insert having a soft grip, comprising the following sequence of steps:
providing a soft grip and an ultrasonic dental scaler insert, said soft grip having a rigid polymeric inner wall and an elastomeric outer wall, said ultrasonic dental scaler insert having a tip, a connector, and a magnetostrictive member, said connector having a first connector end and a second connector end, said first connector end being connected to said tip, said second connector end being connected to said magnetostrictive member, and
affixing said soft grip to said ultrasonic dental scaler insert to form an ultrasonic dental scaler insert having a soft grip.

2. The method of claim 1 wherein said rigid polymeric inner wall is generally cylindrical, and said soft grip is snap-fit onto said connector.

3. The method of claim 1 wherein said rigid polymeric inner wall comprises a first rigid polymeric side and a second rigid polymeric side, said elastomeric outer wall comprises a first elastomeric side and a second elastomeric side, said first elastomeric side is affixed to said first rigid polymeric side, said second elastomeric side is affixed to said second rigid polymeric side, and said rigid polymeric inner wall is formed by affixing said first rigid polymeric side to said second rigid polymeric side.

4. The method of claim 3 wherein said rigid polymeric inner wall circumscribes said connector.

5. The method of claim 1 wherein said soft grip member is generally cylindrical.

6. The method of claim 1 wherein said rigid polymeric inner wall is affixed to said elastomeric outer wall.

7. The method of claim 1 wherein said rigid polymeric inner wall is adhered to said elastomeric outer wall.

8. The method of claim 1 wherein said rigid polymeric inner wall is bonded to said elastomeric outer wall.

9. The method of claim 1 wherein said rigid polymeric inner wall is generally cylindrical and said elastomeric outer wall is generally cylindrical.

10. The method of claim 1 wherein said soft grip member is generally cylindrical and is snap-fit onto said ultrasonic dental scaler insert.

11. The method of claim 1 wherein said rigid polymeric inner wall forms a nozzle for said ultrasonic dental scaler insert.

12. An insert for use in a dental handpiece having a housing having a longitudinal bore, comprising:
a tip,
a magnetostrictive member,
a connecting member,
a nozzle, and
a grip,
said tip being connected to a first end of said connecting member,
said magnetostrictive member being connected to a second end of said connecting member,
said nozzle being supported by said connecting member,
said grip being supported by said nozzle,
said grip comprising rigid polymeric material and elastomeric polymeric material.

13. A method of making an ultrasonic dental scaler insert having a soft grip, comprising:
providing an ultrasonic dental scaler insert having a nozzle and a magnetostrictive member,
providing a soft grip having a rigid polymeric channel supporting an elastomeric layer,
positioning said soft grip member over said nozzle to form an ultrasonic dental scaler insert having a soft grip.

14. The method of claim 13 wherein said rigid polymeric channel is generally cylindrical and said elastomeric layer is generally cylindrical.

15. The method of claim 13 wherein said soft grip is generally cylindrical and is snap-fit onto said ultrasonic dental scaler insert.

16. A method of making an ultrasonic dental scaler insert, comprising the following sequence of steps:
providing an ultrasonic dental scaler insert, and a first soft grip member and a second soft grip member,
said first soft grip having a first rigid polymeric inner wall and a first elastomeric outer wall, said second soft grip having a second rigid polymeric inner wall and a second elastomeric outer wall,
said ultrasonic dental scaler insert having a tip, a connector, and a magnetostrictive member, said connector having an elongated body, a first connector end and a second connector end, said first connector end being connected to said tip, said second connector end being connected to said magnetostrictive member, and
affixing said first soft grip member to said second soft grip member to form a soft grip, whereby said first rigid polymeric inner wall and said second rigid polymeric inner wall circumscribe said elongated body to form an ultrasonic dental scaler insert having a soft grip.

17. A method of making an ultrasonic dental scaler insert having a soft grip, comprising the following sequence of steps:
providing a soft grip member having an elastomeric wall affixed to a rigid wall,
connecting said soft grip member to an ultrasonic dental scaler insert to form an ultrasonic dental scaler insert having a soft grip.

18. The method of claim 17 wherein said ultrasonic dental scaler insert has a tip, a connector, and a magnetostrictive member, said connector having a first connector end connected to said tip, and a second connector end, connected to said magnetostrictive member.

19. The method of claim 18 wherein said rigid wall is generally cylindrical, and said soft grip is snap-fit onto said connector.

20. The method of claim 18 wherein said ultrasonic dental scaler insert further comprises a nozzle and said nozzle comprises said rigid wall.
